(19) United States
(12) Patent Application Publication
(10) Pub. No.: US 2024/0369093 A1
(43) Pub. Date: Nov. 7, 2024

(54) MOUNTING DEVICE FOR A SANITARY ARTICLE

(71) Applicant: Geberit International AG, Jona (CH)

(72) Inventor: Manuel LECHNER, Kaltbrunn (CH)

(73) Assignee: Geberit International AG, Jona (CH)

(21) Appl. No.: 18/687,053

(22) PCT Filed: Jan. 26, 2022
(86) PCT No.: PCT/EP2022/051705

§ 371 Date: Feb. 27, 2024

(30) Foreign Application Priority Data
Sep. 8, 2021 (EP) 21195466.4

(51) Int. Cl. F16B 35/04; A47K 1/00; E03D 11/14

(52) U.S. Cl. CPC F16B 35/048; A47K 1/00; E03D 11/143

(57) ABSTRACT

A mounting device for fastening a sanitary article having at least one support having a support wall that defines a cavity, a first opening and a second opening, wherein the support provides a first support-side stop surface at the first opening and a second support-side stop surface at the second opening, at least one screw, and at least one bearing element with a side wall that extends around a central axis and bounds a receiving space for bearing the screw. The bearing element has at least one first stop surface and at least one second stop surface. The at least one second bearing element-side stop surface is arranged on at least one spring lug. The at least one spring lug and the second bearing element-side stop surface are arranged in such a way that the bearing element is clamped without play between the two support-side stop surfaces.

### TECHNICAL FIELD

The present invention relates to a mounting device for a sanitary article according to claim 1.

### PRIOR ART

Wall fixtures for a mounting frame for sanitary equipment are disclosed in EP 0 786 562 and EP1 260 639. The mounting frame is connected to the wall fixture by a screw. The screw is disposed on the mounting frame via a bearing part which is inserted into a cavity in a support of the mounting frame.

The bearing parts are disposed in the cavity of the mounting frame via locking elements. In practice, it has further been found that the dimensions of cavities in supports may vary considerably, particularly if the surfaces are coated. Owing to these differences in dimensions, the bearing parts are configured in such a way that they always have sufficiently large clearance. This has the advantage that the mounting process is simple, but the disadvantage of a fit which is always oversized.

### SUMMARY OF THE INVENTION

Starting from this prior art, the object of the invention is to lay down a mounting device for a sanitary article which overcomes the disadvantages of the prior art. In particular, it is an object of the present invention to lay down a mounting device for a sanitary article which provides a fixed bearing for a screw. A particularly preferred object is to be able to provide a fixed bearing for a screw despite the high dimensional tolerance of a support element in which the screw is disposed.

This object is achieved by the subject matter according to claim 1. According to this claim, a mounting device for fastening at least one sanitary article comprises at least one support, a screw and a bearing element with which the screw is disposed on the support. The at least one support comprises a support wall, which delimits a cavity, a first opening and a second opening. The openings are arranged in the support wall and oppose each other with respect to the cavity. The openings penetrate the support wall. The support provides a first support-side stop surface at the first opening and a second support-side stop surface at the second opening. The screw has a threaded portion and a screw head. The bearing element has a receiving chamber for bearing the screw. The receiving chamber extends along a center axis. The bearing element has at least one first bearing-element-side stop surface which is in contact with the first support-side stop surface in the mounted state. The bearing element further has at least one second bearing-element-side stop surface, which is in contact with the second support-side stop surface in the mounted state. The at least one second bearing-element-side stop surface is arranged on at least one resilient tab, wherein the at least one resilient tab and the second bearing-element-side stop surface are arranged in such a way that the bearing element is clamped with zero with zero clearance between the two support-side stop surfaces.

In other words, the bearing element is clamped between the two support-side stop surfaces. Arranging the bearing-element-side stop surface on a resilient tab has the advantage that compensation can be made for manufacturing tolerances of the support. Manufacturing tolerances of this type may cause the distance between the two support-side stop surfaces to vary from support to support.

Furthermore, clamping the bearing element in the cavity provides installers with a mounting device which is simpler to handle. In particular, it is simpler to position the screw relative to a wall anchor since the screw is disposed in a secured or fixed manner in the support.

Preferably, the first support-side stop surface is provided by a wall surface, facing the cavity, of the support wall at the first opening. The second support-side stop surface is provided by the edge of the second opening and/or by a wall surface, facing the cavity, of the support wall at the second opening.

Preferably, a plurality of the above-mentioned resilient tabs is arranged. Preferably, the resilient tabs are arranged at regular intervals around the circumference of the lateral wall.

Preferably, when viewed in cross-section, the support wall extends substantially completely around the support axis. The support axis extends centrally through the cavity in the longitudinal direction.

In a preferred embodiment, the mounting device may have two supports, which are located at a distance from each other and are connected by at least one crossbar or transverse cross-member. Preferably, in an embodiment of this type, the sanitary article is disposed on the crossbar or transverse cross-member.

Preferably, the second bearing-element-side stop surface is configured in such a way that the distance between the first bearing-element-side stop surface and the second bearing-element-side stop surface varies depending on the position of the resilient tab.

This makes it possible for the aforementioned clamping to be achieved in a particularly effective manner, irrespective of the internal distance between the two support-side stop surfaces.

Preferably, the second bearing-element-side stop surface is configured in such a way that the distance between the first bearing-element-side stop surface and the second bearing-element-side stop surface is shorter in the case of inward deflection toward the center axis than in the case of increasing distance from the center axis.

Preferably, the second bearing-element-side stop surface is configured so as to be curved with a curve, or that the second bearing-element-side stop surface is configured so as to be inclined in an angled manner at an angle, as viewed relative to the center axis.

The curve and the configuration with an angled incline have the advantage that a very simple structure can be created for tolerance compensation and/or clamping with zero clearance.

Preferably, the curve is configured to be curved about an axis of curvature, wherein the axis of curvature extends at a distance from and transversely to the center axis. Preferably, the curve is selected in such a way that, when the curve is positioned adjacent to the support-side stop surface, the angle of the tangent at the contact point is substantially identical for all support dimensions, i.e., the second bearing-element-side stop surface is positioned adjacent to the support-side stop surface at an identical angle in every position of the resilient tab.

Preferably, the second bearing-element-side stop surface has a step which divides the second bearing-element-side stop surface into two surface portions. The step has the particular advantage that the bearing element can be used in the case of different support dimensions, for example for supports with different wall thicknesses.

Preferably, the at least one resilient tab extends so as to be inclined in an angled manner at an angle α to the center axis. Preferably, the angle α is in the range of from 3° to 35°. In particular in the mounted state, the resilient tab extends so as to be inclined in an angled manner relative to the center axis. When the bearing element is inserted into the two openings and the cavity, the at least one resilient tab is pivoted toward the center axis.

Preferably, the bearing element further has at least one locking tab on which a locking cam is integrally formed, wherein the locking cam engages in a groove arranged on the screw.

The locking tab is preferably formed by two slots which extend in the direction of the center axis through the lateral wall mentioned below.

Preferably, the first bearing-element-side stop surface is provided by a shoulder positioned on the lateral wall mentioned below or the outer lateral wall mentioned below.

Preferably, a guide portion with a cylindrical guide surface extends away from the first stop surface. The guide portion projects into the first opening.

Preferably, the above-mentioned resilient tabs with the second bearing-element-side stop surface are configured so as to be identical to one another.

Preferably, the bearing element has at least one further resilient tab, which has a further stop surface. The further stop surface may be brought into contact with the second support-side stop surface and may provide a further stop in the event of mechanical failure of the contact between the second bearing-element-side stop surface and the second support-side stop surface.

Preferably, the further stop surface is arranged so as to be offset relative to the second bearing-element-side stop surface in the direction of the center axis and is located in particular closer to the first bearing-element-side stop surface than the second bearing-element-side stop surface. In the mounted state, the further stop surface is therefore located at a distance from the second support-side stop surface.

Preferably, the further stop surface is oriented substantially at right angles to the center axis, as viewed in cross-section through the center axis.

Preferably, the at least one further resilient tab has a bearing surface adjoining the stop surface, wherein the bearing surface is in contact with the interior of the opening in the mounted state.

Preferably, four of the above-mentioned further resilient tabs are arranged, wherein the four resilient tabs are preferably arranged at a uniform distance from one another.

Preferably, a plurality of the further resilient tabs is arranged, wherein preferably two opposing further resilient tabs form a first pair and wherein two opposing further resilient tabs form a second pair, wherein the width of the resilient tabs of the first pair is identical to the width of the resilient tabs of the second pair, or wherein the width of the resilient tabs of the first pair is not identical to the width of the resilient tabs of the second pair.

Preferably, at least two of the above-mentioned further resilient tabs have differing widths.

Preferably, at least one resilient tab with the second bearing-element-side stop surface is positioned between two of the further resilient tabs; in particular, that at least two resilient tabs are positioned between two of the further resilient tabs.

Preferably, the resilient tabs and the further resilient tabs are each of identical length.

Preferably, the further resilient tabs are likewise integrally formed on the lateral wall via a tab portion.

The bearing element is preferably produced from a plastics material, such as polybutylene terephthalate (PBT) or polyamide (PA). The supports are preferably made of steel and have a rectangular or square cross-sectional shape.

The bearing element may be configured in one or two pieces.

If the bearing element is provided in one piece, the receiving chamber is delimited by a lateral wall.

Preferably, the resilient tab is connected to the lateral wall via a first tab portion, which extends from the exterior of the lateral wall so as to be inclined in an angled manner at an angle.

Preferably, the lateral wall has a contact surface for the screw head of the screw, wherein the contact surface, as viewed from the second bearing-element-side stop surface, is arranged with an offset so as to be offset in a rearward direction, wherein the offset is such that the screw head comes to be positioned substantially completely or completely between the contact surface and the second bearing-element-side stop surface.

In other words, the screw head comes to be positioned in the region of the offset and is thus surrounded externally in a radial manner by the bearing element. Furthermore, the screw head does not protrude on the side of the second bearing-element-side stop surface, and is rather recessed in the region of the offset. As viewed from the lateral wall, the resilient tabs extend over the contact surface.

If the at least one bearing element is configured in two pieces, it is configured with an inner bearing element part and an outer bearing element part. The inner bearing element part is disposed in the outer bearing element part so as to be displaceable. The inner bearing element part has the receiving chamber in which the screw is received. The outer bearing element part has the at least one first bearing-element-side stop surface and the at least one second bearing-element-side stop surface.

Preferably, the inner bearing element part is displaceable relative to the outer bearing element part from an initial position into a mounting position, wherein in the initial position the inner bearing element part is locked to the outer bearing element part via a first locking connection, wherein during the mounting process the first locking connection is released and the inner bearing element part is displaceable relative to the outer bearing element part into the mounting position, and wherein in the mounting position the inner bearing element part locks to the outer bearing element part via a second locking connection.

Preferably, the inner bearing element part has at least one surface which presses the at least one resilient tab outward when the inner bearing element part is in the mounting position. Preferably, the at least one resilient tab is pressed radially outward.

Preferably, the receiving chamber in the inner bearing element part is delimited by a lateral wall, wherein the lateral wall has a contact surface for the screw head of the screw, wherein the contact surface, as viewed from the second bearing-element-side stop surface, is arranged with an offset so as to be offset in a rearward direction, wherein the offset is such that the screw head comes to be positioned substantially completely or completely between the contact surface and the second bearing-element-side stop surface.

Preferably, the outer bearing element part has an outer lateral wall, from which the at least one resilient tab protrudes, and that the first bearing-element-side stop surface is provided by a shoulder positioned on the outer lateral wall.

Preferably, the further resilient tab previously mentioned extends away from the outer lateral wall of the outer bearing element part in the two-part embodiment.

Further embodiments are laid down in the dependent claims.

### BRIEF DESCRIPTION OF THE DRAWINGS

Preferred embodiments of the invention are described in the following with reference to the drawings, which are provided for illustrative purposes only and are not to be interpreted as restrictive. In the drawings:

FIG. 1 shows a perspective view of a mounting device according to a preferred first embodiment of the present invention;

FIG. 2 shows a further perspective view of the mounting device according to FIG. 1;

FIG. 3 shows a perspective view of the mounting device according to FIG. 1, with a partly inserted bearing element and screw;

FIG. 4 shows a perspective view of a bearing element with an inserted screw for use in the mounting device according to any one of the preceding figures;

FIG. 5 shows a perspective view of a bearing element for use in the mounting device according to any one of the preceding figures;

FIG. 6 shows a sectional view through the mounting device according to the preceding figures;

FIG. 7 shows a further sectional view through the mounting device according to the preceding figures; and

FIG. 8 shows a further sectional view through the mounting device according to the preceding figures;

FIG. 9 shows a perspective view of a mounting device according to a preferred second embodiment of the present invention;

FIG. 10 shows a further perspective view of the mounting device according to FIG. 2;

FIG. 11a/b show detail views of the mounting device according to FIGS. 9 and 10;

FIG. 12a/b/c show sectional views of the mounting device according to FIGS. 9 to 11 in an initial position; and

FIG. 13a/b/c show sectional views of the mounting device according to FIGS. 9 to 11 in a mounting position.

### DESCRIPTION OF PREFERRED EMBODIMENTS

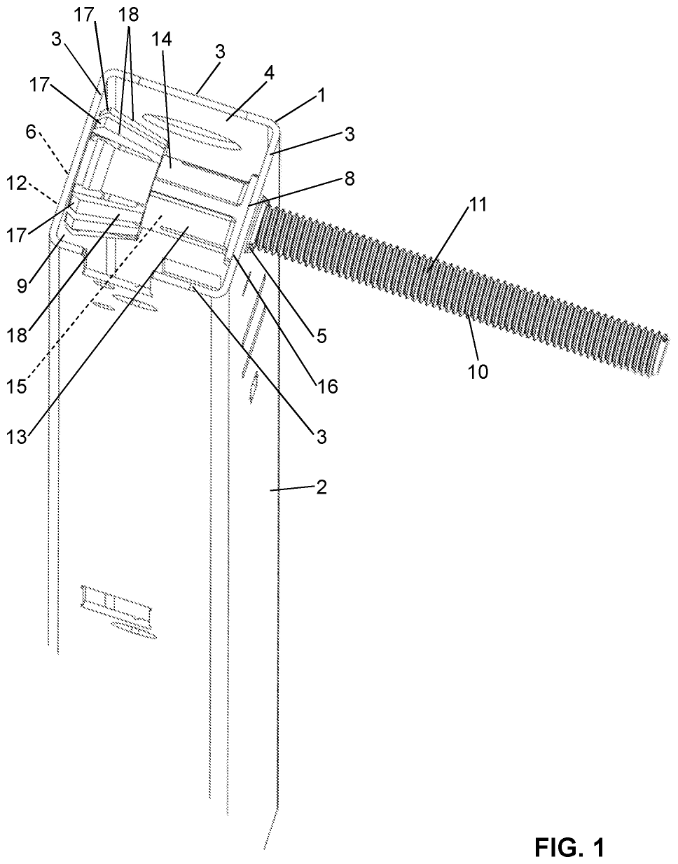

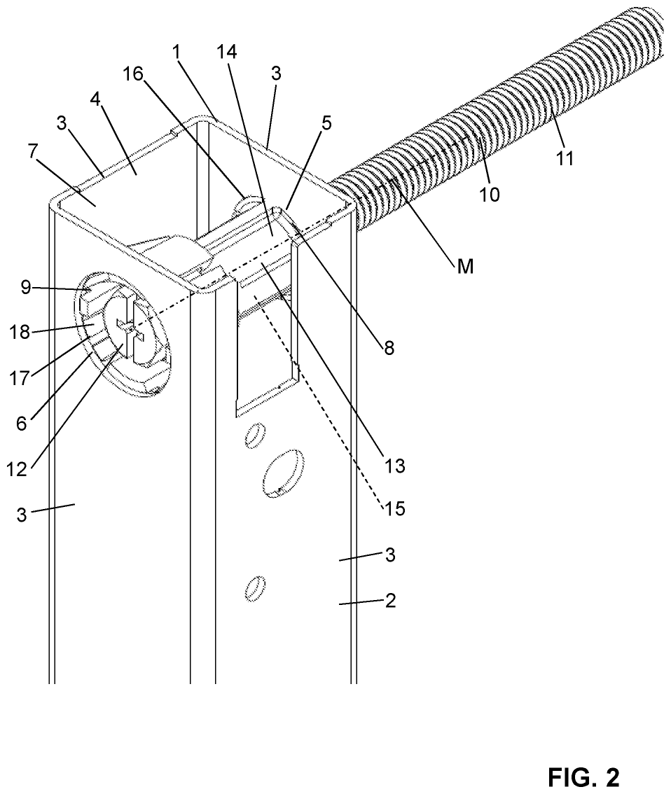

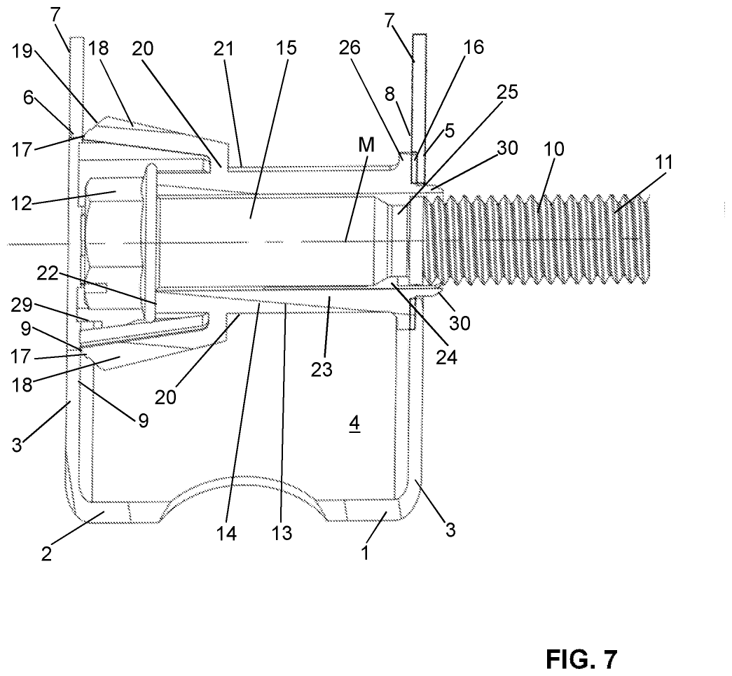

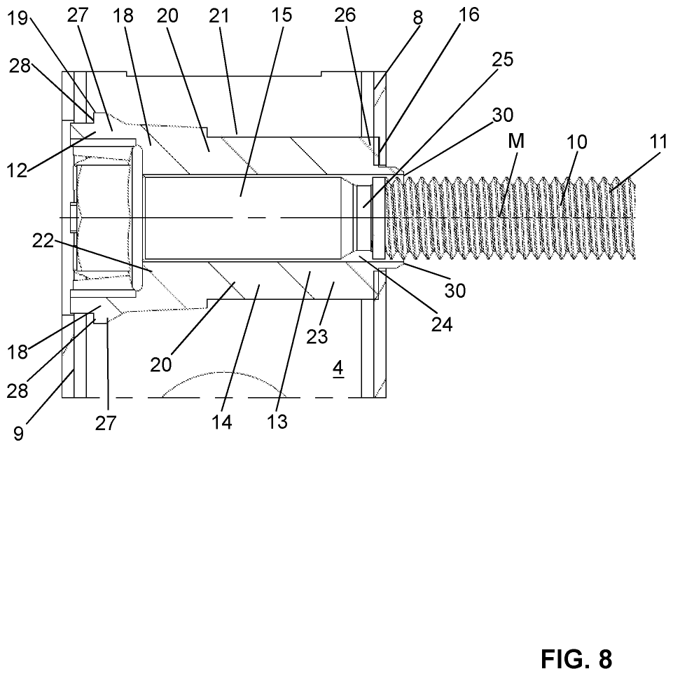

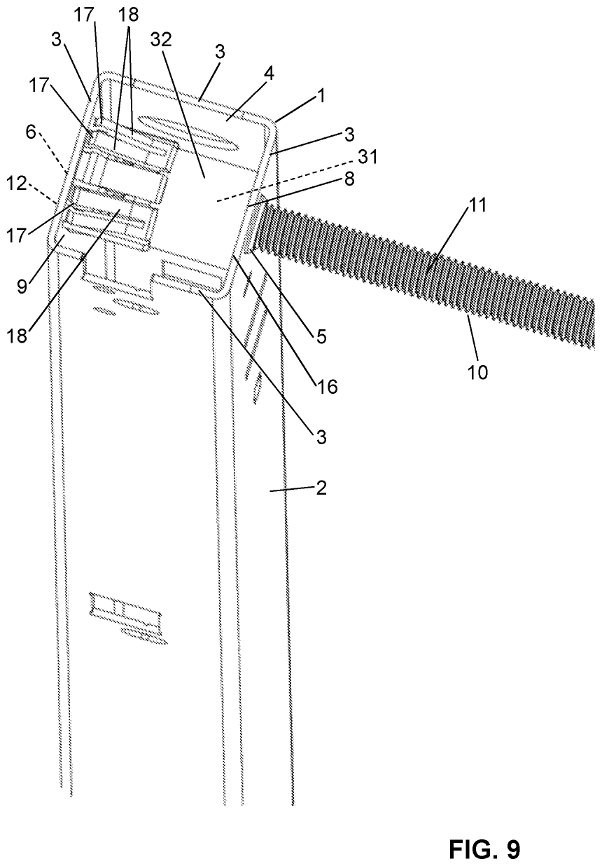

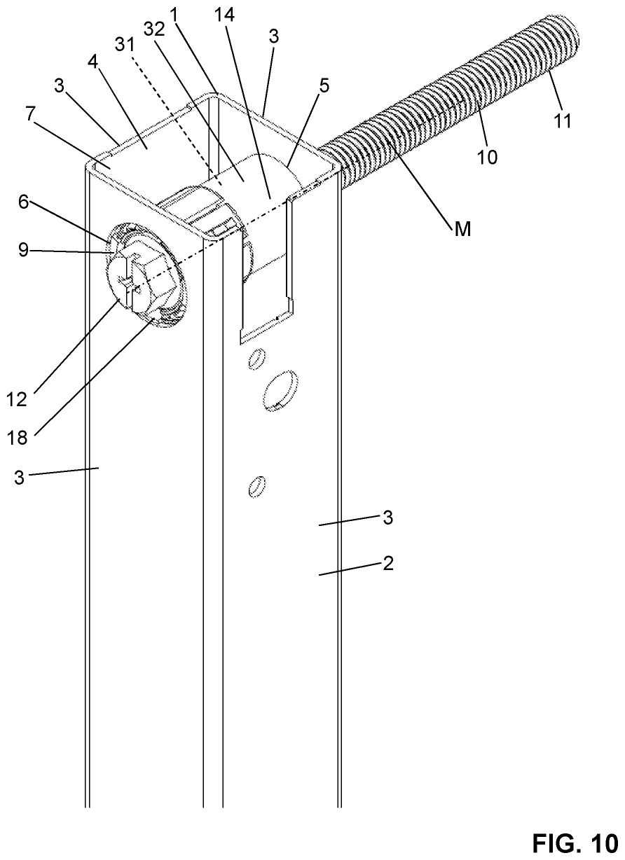

The figures show details or parts of a mounting device 1 for fastening at least one sanitary article. The sanitary article is for example a washstand, a toilet bowl, a urinal, a cistern, etc. FIGS. 1 to 8 show a first embodiment and FIGS. 9 to 13c show a second embodiment of the present invention. Like parts are provided with like reference signs.

The mounting device 1 comprises at least one support 2, at least one screw 10 and at least one bearing element 13, via which the screw 10 is disposed in the support 2. The support 2 may be connected to a further support 2 by at least one cross-member. The support 2 or the at least one cross-member may have fastening points for fastening the at least one sanitary article. One bearing element 13 and therefore one screw 10 may be arranged per support 2. However, it is also conceivable that a plurality of bearing elements 13 and therefore a plurality of screws 10 is arranged per support 2.

The support 2 has a support wall 3. The support wall 3 defines a cavity 4. A first opening 5 and a second opening 6 extend through the support wall 3. The first opening 5 is arranged opposite the second opening 6 with respect to the cavity 4. The wall surface 7, facing the cavity 4, of the support wall 3 at the first opening 5 provides a first support-side stop surface 8. The wall surface 7, facing the cavity 4, of the support wall 3 at the second opening 6 and/or the edge of the second opening 6 facing toward the cavity provide(s) a second support-side stop surface 9. The position element 13 may abut these stop surfaces 8, 9 in the installed state.

The screw 10 comprises a threaded portion 11 and a screw head 12. The threaded portion 11 engages in an anchor element fastened to a load-bearing structure (not shown in the figures) and is thus secured to the load-bearing structure.

In the first embodiment, the bearing element 13 is configured in one piece. In the second embodiment, the bearing element 13 is configured in a plurality of parts, with an inner bearing element part 31 and an outer bearing element part 32. The bearing element 13 has a receiving chamber 15. The screw 10 is disposed in the receiving chamber 15. The bearing element 13 has at least one first bearing-element-side stop surface 16. In the mounted state, i.e., when the bearing element 13 is connected to the support 2, the first bearing-element-side stop surface 16 is in contact with the first support-side stop surface 9. Furthermore, the bearing element 13 has at least one second bearing-element-side stop surface 17. In the mounted state, the second bearing-element-side stop surface 17 is in contact with the second support-side stop surface 9.

The at least one second bearing-element-side stop surface 17 is arranged on at least one resilient tab 18. The at least one resilient tab 18 and the second bearing-element-side stop surface 17 are arranged in such a way that the bearing element 13 is clamped with zero clearance between the two support-side stop surfaces 8, 9. The resilience of the resilient tab 18 makes it possible to achieve the aforementioned clamping effect.

In other words, the bearing element 13 is clamped between the two support-side stop surfaces 8, 9. The resilient tab 18, on which the stop surface 17 is arranged, makes it possible to compensate for the dimensional tolerances of the cavity or the distance between the two stop surfaces 8, 9.

FIGS. 1 and 2, and 9 and 10 show partial perspective views of the mounting device 1. These figures show how the stop surfaces abut one another as described above. In the mounted position, the bearing element 13 is disposed substantially completely in the support 2. The bearing element 13 extends transversely through the cavity 5 from the first opening 5 to the second opening 6. Furthermore, the screw 10 extends through the receiving chamber 15 and projects, via the threaded portion 11, from the first opening 5. The screw head 12 is accessible from the second opening 6. The screw 10 is disposed in the receiving chamber 15 in an axially fixed and rotatable manner.

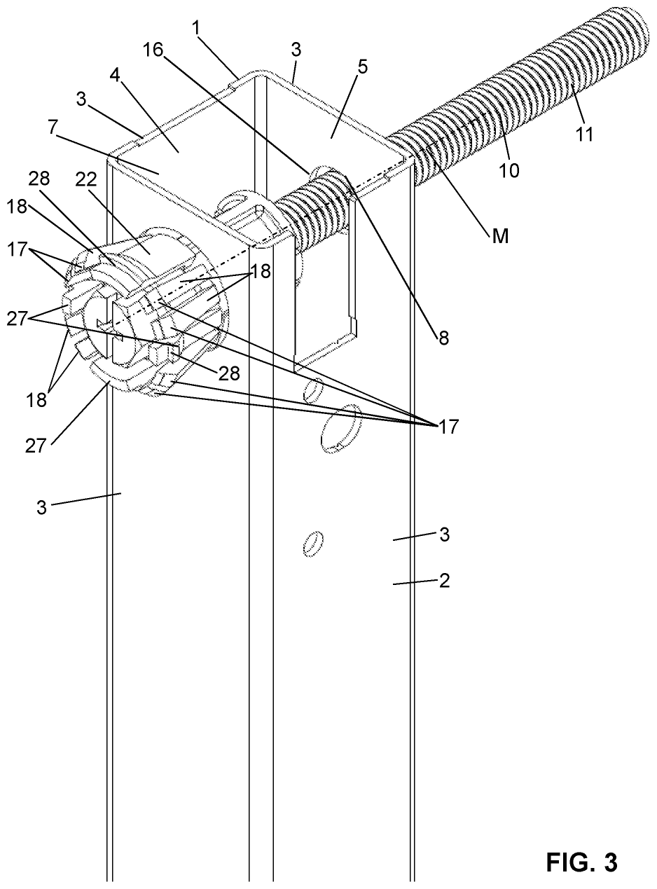

FIG. 3 shows a perspective view of the mounting device 1, wherein the bearing element 13 and the screw 10 are not yet fully in the mounted state.

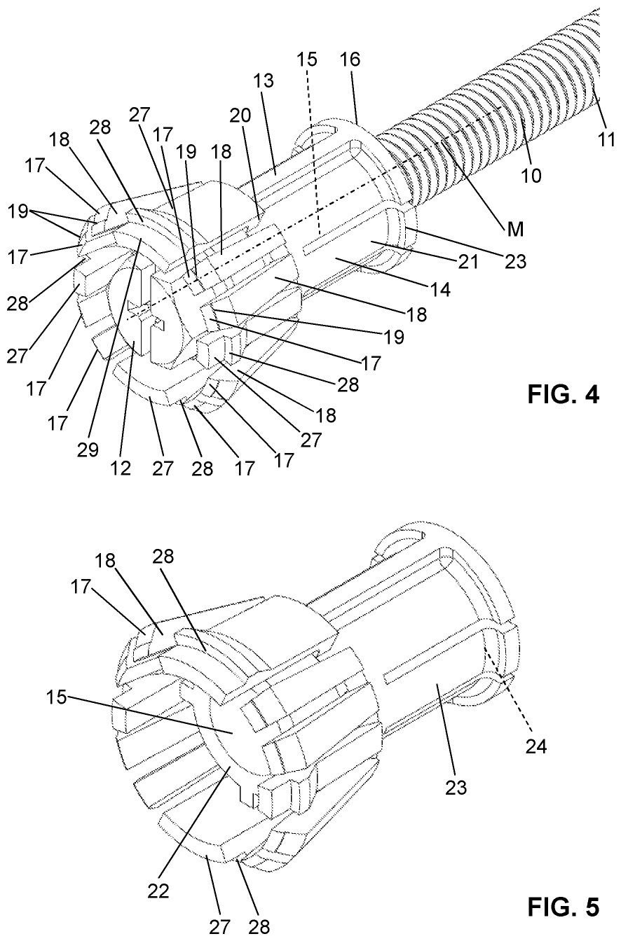

FIGS. 4 and 5 show detail views of the bearing element 13 and the screw 10, and the bearing element 13 alone, respectively.

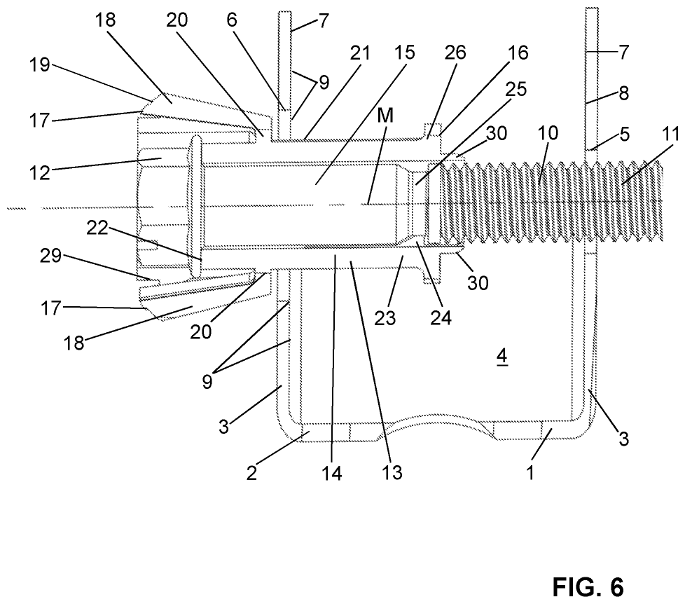

FIGS. 6 to 8 show plan views of the mounting device 1.

Further preferred features of the mounting device 1 will now be explained in greater detail with reference to all figures.

The second bearing-element-side stop surface 17 is configured in such a way that the distance between the first bearing-element-side stop surface 16 and the second bearing-element-side stop surface 17 varies depending on the position of the resilient tab 18. This ensures that the two bearing-element-side stop surfaces 16, 17 are in contact with the corresponding stop surfaces 8, 9 on the support 2, irrespective of the dimensional tolerance deviation of the supports 2.

In the embodiment shown, the second bearing-element-side stop surface 17 is configured so as to be curved with a curve. The curve extends about an axis of curvature, which is oriented at right angles to and at a distance from the center axis M. The second bearing-element-side stop surface 17 has a step 19 which divides the second bearing-element-side stop surface 17 into two surface portions.

In the embodiment shown, the at least one resilient tab 18 extends so as to be inclined in an angled manner at an angle α to the center axis M. When the bearing element 13 is being mounted, the resilient tab 18 deflects inward toward the center axis M and then moves back toward the initial position from a deflected position due to the resilient properties thereof. During this movement, the second bearing-element-side stop surface 17 comes into contact with the second support-side stop surface 9.

In the embodiment shown, a plurality of resilient tabs 18 is arranged. The resilient tabs 18 are configured so as to be identical to one another. The resilient tabs 18 are arranged in a distributed manner around the circumference of a lateral wall 14 of the bearing element 11. The resilient tabs 18 are connected to the lateral wall 14 via a tab portion 20 which extends from the exterior 21 of the lateral wall 14 so as to be inclined in an angled manner at an angle. In this case, the tab portion 20 extends substantially at right angles to the center axis M and

The bearing element 13 has at least one further resilient tab 27, which is arranged in addition to the at least one resilient tab 18 with the second bearing-element-side stop surface 17. This further resilient tab 27 is shown in FIGS. 4, 5 and 8. The further resilient tab 27 has a further stop surface 28. The further stop surface 28 is arranged so as to be offset relative to the second bearing-element-side stop surface 17 in the direction of the center axis M. In particular, the further stop surface 28 is located closer to the first bearing-element-side stop surface 16 than the second bearing-element-side stop surface 16. The at least one further resilient tab 27 further has a bearing surface 29 adjoining the stop surface 28, wherein the bearing surface is in contact with the interior of the second opening 6 in the mounted state.

In the embodiment shown, a guide portion 30 extends away from the lateral wall 14 opposite the resilient tab 18. The guide portion 30 adjoins the first bearing-element-side stop surface 16. The guide portion 30 comes into contact with the interior of the first opening 5. The guide portion 30 has a cylindrical shape. A shoulder 26, which provides the first bearing-element-side stop surface 16, extends from the guide portion 30.

Furthermore, opposite the bearing surface 29, the lateral wall 14 has a contact surface 22 for the screw head 12 of the screw 10. The contact surface 22, as viewed from the second bearing-element-side stop surface 17, is arranged with an offset so as to be offset in a rearward direction. This offset creates a chamber in which the screw head 12 comes to be positioned. Preferably, the offset is such that the screw head 12 comes to be positioned substantially completely or completely between the contact surface 22 and the second bearing-element-side stop surface 17, i.e., the screw head 12 is positioned substantially completely in the aforementioned chamber.

Furthermore, the bearing element 13 has a locking tab 23, on which a locking cam 24 is integrally formed. The locking cam 24 engages in a groove 25 arranged on the screw 10. The screw 10 is secured axially in the receiving chamber 15 via the connection between the locking cam 24 and the groove 25. The screw 10 is accordingly rotatably arranged receiving chamber 15.

In the embodiment shown, four of the above-mentioned further resilient tabs 27 are arranged, wherein the four resilient tabs 27 are arranged at a preferably uniform distance from one another. Two opposing further resilient tabs 27 form a first pair and two opposing further resilient tabs 27 form a second pair. The width of the resilient tabs 27 of the first pair is not identical to the width of the resilient tabs 27 of the other pair.

In the embodiment shown, at least one resilient tab 18 with the second bearing-element-side stop surface 17 is positioned between two of the further resilient tabs 27. In this case, two resilient tabs 17 are positioned between two of the further resilient tabs 27.

According to the first embodiment as shown in FIGS. 1 to 8, the bearing element 11 is configured in one piece. The bearing element has a lateral wall 14 which extends around a center axis M. The lateral wall 14 delimits the receiving chamber 15.

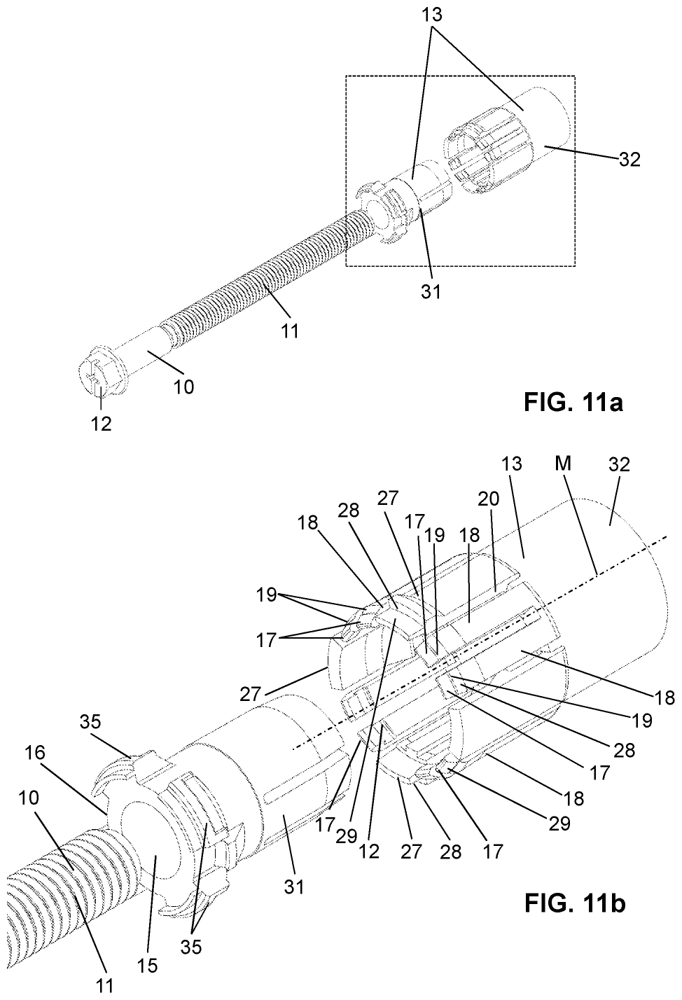

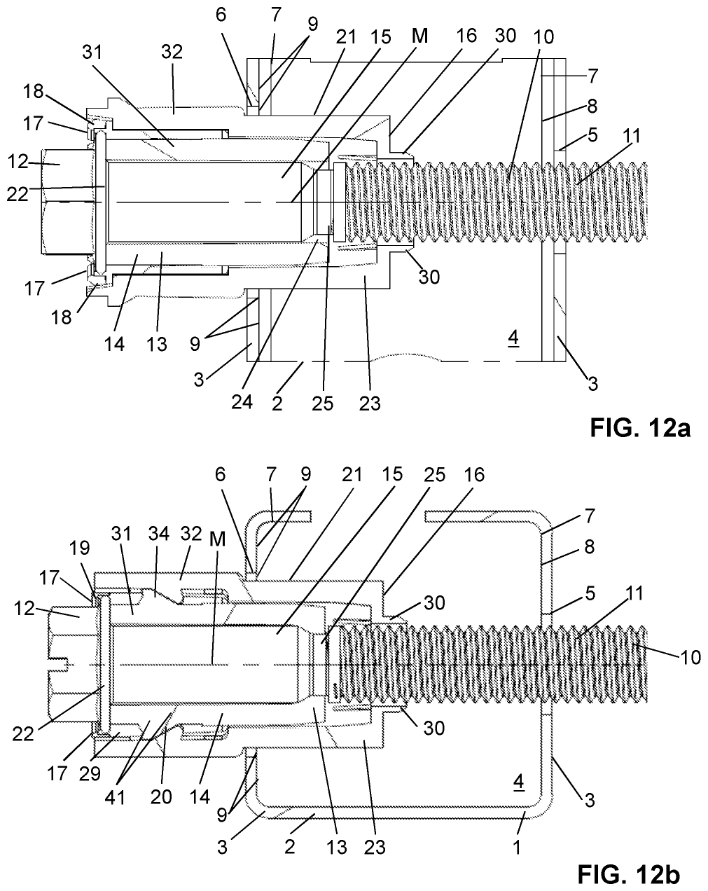

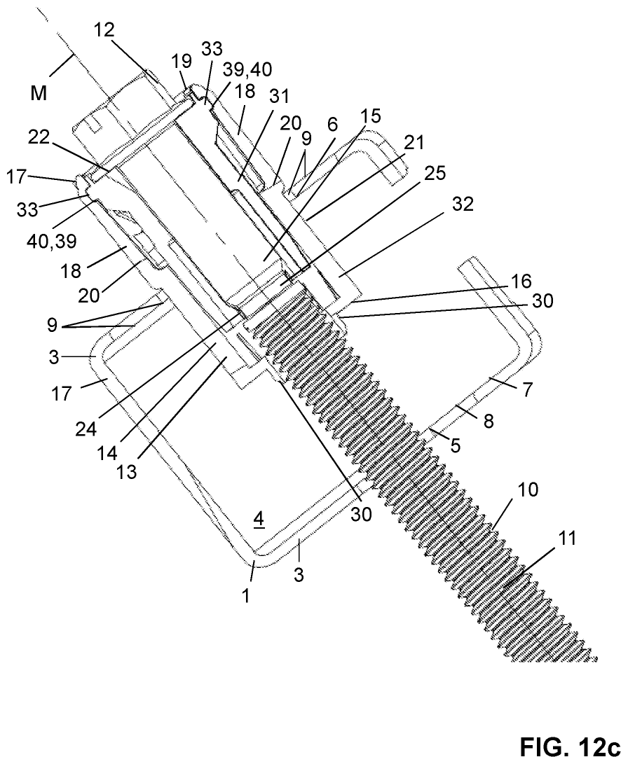

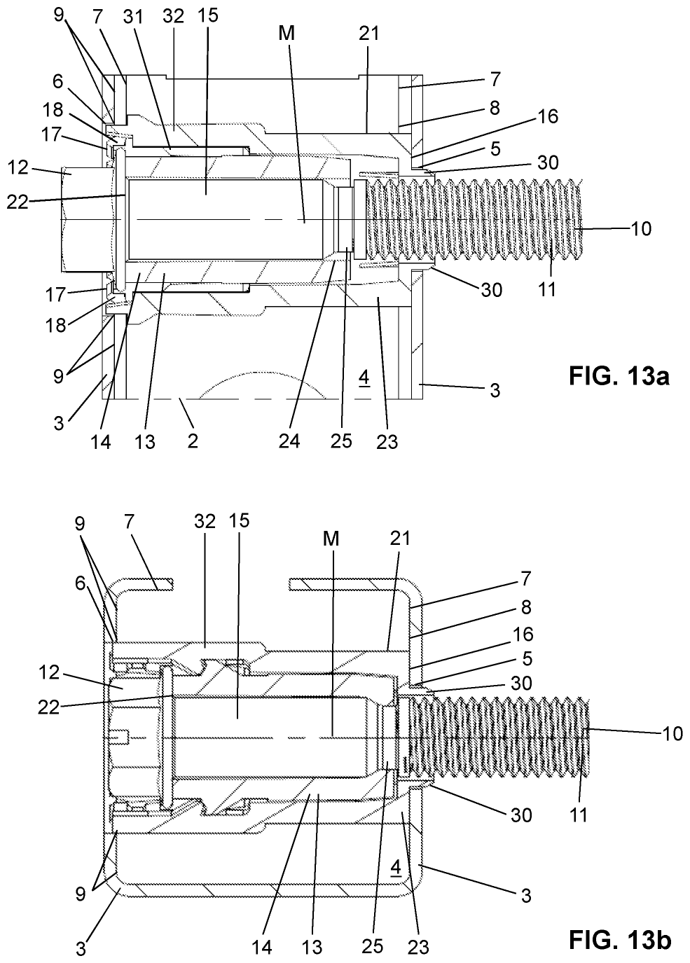

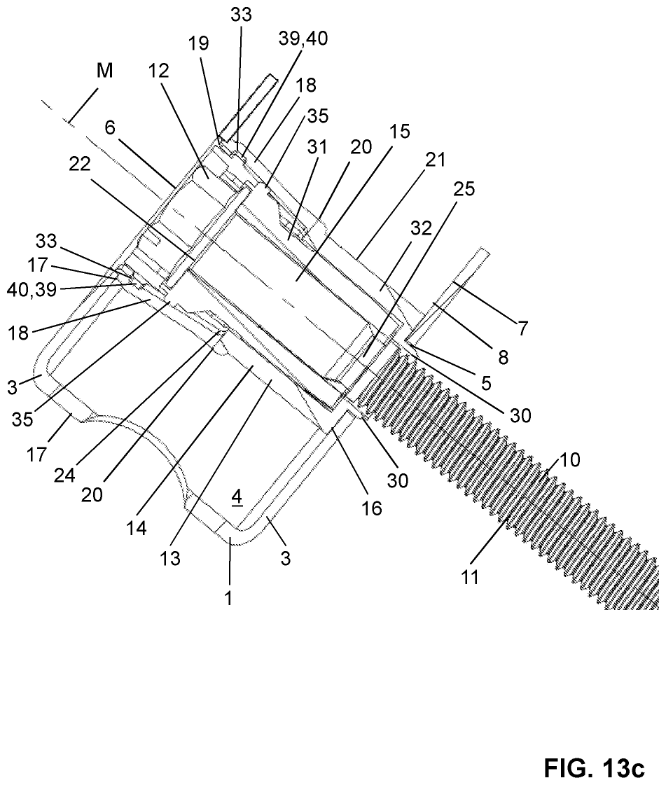

According to the second embodiment, the bearing element 13 is configured in two parts. The bearing element 13 comprises an inner bearing element part 31 and an outer bearing element part 32. The two bearing element parts 31 and 32 are shown in greater detail in FIGS. 11a and 11b. FIGS. 12a to 12c and 13a to 13c show sectional views. The inner bearing element part 31 is disposed in the outer bearing element part 32 so as to be displaceable.

The inner bearing element part 31 has the receiving chamber 15, in which the screw 10 is disposed. The outer bearing element part 32 has the at least one first bearing-element-side stop surface 16 and the at least one second bearing-element-side stop surface 17.

The inner bearing element part 31 is displaceable from an initial position into a mounting position. In the initial position, the inner bearing element part 31 is locked to the outer bearing element part 32 via a first locking connection 33. The first locking connection is provided by a locking cam 39 and a locking recess 40, in which the locking cam 39 engages.

During the mounting process, the first locking connection 32 is released and the inner bearing element part 31 is displaced relative to the outer bearing element part 32 into the mounting position.

In the mounting position, the inner bearing element part 31 is locked to the outer bearing element part 32 via a second locking connection 34. As shown in FIGS. 13a to 13c, the second locking connection 34 is provided by two locking projections 41 arranged in a diametrically opposed manner.

The receiving chamber 15 in the inner bearing element part 31 is delimited by a lateral wall 14. The lateral wall 14 has a contact surface 22 for the screw head 12 of the screw 10. The contact surface 22, as viewed from the second bearing-element-side stop surface 17, is arranged with an offset so as to be offset in a rearward direction, wherein the offset is such that the screw head 12 comes to be positioned substantially completely or completely between the contact surface 22 and the second bearing-element-side stop surface 17. Opposite the contact surface 22, the inner bearing element part 31 has a bearing surface 36. When the inner bearing element part 31 is in the mounting position, the bearing surface 36 is positioned against a corresponding bearing surface 37 on the outer bearing element part 32.

Furthermore, the outer bearing element part 32 has an outer lateral wall 38. The at least one resilient tab 18 protrudes from the outer lateral wall. In the embodiment shown, the optional at least one further resilient tab 27 with the further stop surface 28 is also arranged in a protruding manner on the outer lateral wall. The first bearing-element-side stop surface 16 is provided by a shoulder 26 positioned on the outer lateral wall 14. Furthermore, the outer lateral wall 38 also comprises the first bearing-element-side stop surface 16.

In the preferred embodiment, the inner bearing element part 32 has at least one surface 35 which presses the at least one resilient tab 18 radially outward when the inner bearing element part 32 is in the mounting position. If the inner bearing element part 32 is displaced into the initial position, the surface 35 comes to be positioned in a region in which the at least one resilient tab 18 is no longer blocked. The surface 35 is shown in FIG. 13c. In this case, the surface 35 forms part of the locking cam 39. If the further resilient tab 27 is provided, it is also conceivable that a further surface 35 acts on the further resilient tab 27.

As in the first embodiment, the screw 10 is likewise held in the receiving chamber via a locking cam 24.

When the mounting device according to the second embodiment is disassembled, the inner bearing element part 32 is to be moved from the mounting position to the initial position. Preferably, the inner bearing element part 31 is disposed in the outer bearing element part 32 in a rotationally fixed and axially displaceable manner.

### LIST OF REFERENCE SIGNS

| | |
|---|---|
| 1 | mounting device |
| 2 | support |
| 3 | support wall |
| 4 | cavity |
| 5 | opening |
| 6 | opening |
| 7 | wall surface |
| 8 | first support-side stop surface |
| 9 | second support-side stop surface |
| 10 | screw |
| 11 | threaded portion |
| 12 | screw head |
| 13 | bearing element |
| 14 | lateral wall |
| 15 | receiving chamber |
| 16 | first bearing-element-side stop surface |
| 17 | second bearing-element-side stop surface |
| 18 | resilient tab |
| 19 | step |
| 20 | tab portion |
| 21 | exterior |
| 22 | contact surface |
| 23 | locking tab |
| 24 | locking cam |
| 25 | groove |
| 26 | shoulder |
| 27 | further resilient tab |
| 28 | further stop surface |
| 29 | bearing surface |
| 30 | guide portion |
| 31 | inner bearing element part |
| 32 | outer bearing element part |
| 33 | first locking connection |
| 34 | second locking connection |
| 35 | surface |
| 36 | bearing surface |
| 37 | corresponding bearing surface |
| 38 | outer lateral wall |
| 39 | locking cam |
| 40 | locking recess |
| 41 | locking projection |
| M | center axis |

1-22. (canceled)

22. A mounting device for fastening at least one sanitary article, comprising
at least one support with a support wall, which delimits a cavity, a first opening and a second opening, these openings being arranged in the support wall and opposing each other with respect to the cavity, wherein the support provides a first support-side stop surface at the first opening and a second support-side stop surface at the second opening,
at least one screw with a threaded portion and a screw head, and
at least one bearing element with a receiving chamber, which extends along a center axis, for bearing the screw, wherein the bearing element has at least one first bearing-element-side stop surface which is in contact with the first support-side stop surface in the mounted state, and wherein the bearing element has at least one second bearing-element-side stop surface, which is in contact with the second support-side stop surface in the mounted state,
wherein the at least one second bearing-element-side stop surface is arranged on at least one resilient tab, wherein the at least one resilient tab and the second bearing-element-side stop surface are arranged in such a way that the bearing element is clamped with zero clearance between the two support-side stop surfaces.

23. The mounting device as claimed in claim 22, wherein the second bearing-element-side stop surface is configured in such a way that the distance between the first bearing-element-side stop surface and the second bearing-element-side stop surface varies depending on the position of the resilient tab.

24. The mounting device as claimed in claim 22, wherein the second bearing-element-side stop surface is configured so as to be curved with a curve, or wherein the second bearing-element-side stop surface is configured so as to be inclined in an angled manner at an angle, as viewed relative to the center axis.

25. The mounting device as claimed in claim 22, wherein the second bearing-element-side stop surface has a step which divides the second bearing-element-side stop surface into two surface portions.

26. The mounting device as claimed in claim 22, wherein the at least one resilient tab extends so as to be inclined in an angled manner at an angle to the center axis.

27. The mounting device as claimed in claim 22, wherein the bearing element further has a locking tab on which a locking cam is integrally formed, wherein the locking cam engages in a groove arranged on the screw.

28. The mounting device as claimed in claim 22, wherein the above-mentioned resilient tabs with the second bearing-element-side stop surface are configured so as to be identical to one another.

29. The mounting device as claimed in claim 22, wherein the bearing element has at least one further resilient tab, which has a further stop surface.

30. The mounting device as claimed in claim 29, wherein the further stop surface is arranged so as to be offset relative to the second bearing-element-side stop surface in the direction of the center axis.

31. The mounting device as claimed in claim 29, wherein the further stop surface is arranged so as to be offset relative to the second bearing-element-side stop surface in the direction of the center axis and is located closer to the first bearing-element-side stop surface than the second bearing-element-side stop surface.

32. The mounting device as claimed in claim 29, wherein the at least one further resilient tab has a bearing surface adjoining the stop surface, wherein the bearing surface is in contact with the interior of the second opening in the mounted state.

33. The mounting device as claimed in claim 29, wherein four of the above-mentioned further resilient tabs are arranged.

34. The mounting device as claimed in claim 29, wherein four of the above-mentioned further resilient tabs are arranged, wherein the four resilient tabs are arranged at a preferably uniform distance from one another.

35. The mounting device as claimed in claim 29, wherein a plurality of the further resilient tabs is arranged, wherein two opposing further resilient tabs form a first pair, and wherein two opposing further resilient tabs form a second pair, wherein the width of the resilient tabs of the first pair is identical to the width of the resilient tabs of the other pair, or wherein the width of the resilient tabs of the first pair is not identical to the width of the resilient tabs of the other pair.

36. The mounting device as claimed in claim 29, wherein at least one resilient tab with the second bearing-element-side stop surface is positioned between two of the further resilient tabs.

37. Mounting device as claimed in claim 29, wherein at least one resilient tab with the second bearing-element-side stop surface is positioned between two of the further resilient tabs; and wherein at least two resilient tabs are positioned between two of the further resilient tabs.

38. The mounting device as claimed in claim 22, wherein the at least one bearing element is configured in one piece.

39. The mounting device as claimed claim 22, wherein the receiving chamber is delimited by a lateral wall.

40. The mounting device as claimed in claim 39,
wherein the receiving chamber is delimited by a lateral wall; and wherein the resilient tabs are connected to the lateral wall via a tab portion which extends from the exterior of the lateral wall so as to be inclined in an angled manner at an angle; and/or
wherein the receiving chamber is delimited by a lateral wall; and wherein the lateral wall has a contact surface for the screw head of the screw, wherein the contact surface, as viewed from the second bearing-element-side stop surface, is arranged with an offset so as to be offset in a rearward direction, wherein the offset is such that the screw head comes to be positioned substantially completely or completely between the contact surface and the second bearing-element-side stop surface; and/or
wherein the receiving chamber is delimited by a lateral wall; and wherein the first bearing-element-side stop surface is provided by a shoulder positioned on the lateral wall.

41. The mounting device as claimed in claim 22, wherein the at least one bearing element is configured in two pieces, with an inner bearing element part and an outer bearing element part,
wherein the inner bearing element part is disposed in the outer bearing element part so as to be displaceable,
wherein the inner bearing element part has the receiving chamber and
wherein the outer bearing element part has the at least one first bearing-element-side stop surface and the at least one second bearing-element-side stop surface.

42. The mounting device as claimed in claim 41, wherein the inner bearing element part is displaceable from an initial position into a mounting position,
wherein, in the initial position, the inner bearing element part is locked to the outer bearing element part via a first locking connection,
wherein, during the mounting process, the first locking connection is released and the inner bearing element part is displaceable relative to the outer bearing element part into the mounting position,
and wherein, in the mounting position, the inner bearing element part is locked to the outer bearing element part via a second locking connection.

43. The mounting device as claimed in claim 41, wherein the inner bearing element part has at least one surface which presses the at least one resilient tab outward when the inner bearing element part is in the mounting position.

44. The mounting device as claimed in claim 41, wherein the receiving chamber in the inner bearing element part is delimited by a lateral wall, wherein the lateral wall has a contact surface for the screw head of the screw, wherein the contact surface, as viewed from the second bearing-element-side stop surface, is arranged with an offset so as to be offset in a rearward direction, wherein the offset is such that the screw head comes to be positioned substantially completely or completely between the contact surface and the second bearing-element-side stop surface.

45. The mounting device as claimed in claim 44, wherein the receiving chamber in the inner bearing element part is delimited by a lateral wall, wherein the lateral wall has a contact surface for the screw head of the screw, wherein the contact surface, as viewed from the second bearing-element-side stop surface, is arranged with an offset so as to be offset in a rearward direction, wherein the offset is such that the screw head comes to be positioned substantially completely or completely between the contact surface and the second bearing-element-side stop surface; and wherein the outer bearing element part has an outer lateral wall, from which the at least one resilient tab protrudes, and wherein the first bearing-element-side stop surface is provided by a shoulder positioned on the outer lateral wall.
